(19) United States
(12) Patent Application Publication
(10) Pub. No.: US 2015/0067591 A1
(43) Pub. Date: Mar. 5, 2015

(54) SYSTEM AND METHOD FOR DECOUPLING WINDOWS FROM THE DESKTOP IT WAS CREATED ON IN A MULTIPLE DESKTOP ENVIRONMENT

(71) Applicant: MOSAIQQ, Inc., San Francisco, CA (US)

(72) Inventors: Anders Nancke-Krogh, San Francisco, CA (US); Nina Nancke-Krogh, San Francisco, CA (US)

(21) Appl. No.: 14/478,993

(22) Filed: Sep. 5, 2014

Related U.S. Application Data
(60) Provisional application No. 61/874,295, filed on Sep. 5, 2013.

(51) Int. Cl. G06F 3/0481

(52) U.S. Cl. CPC G06F 3/0481
USPC 715/804

(57) ABSTRACT

Embodiments are generally related to computer systems and user-computer interactions, and are in particular related to systems and methods for decoupling windows from the desktop it was created on in a multiple desktop environment. More specifically, disclosed are systems, components, and methods to enable collaborative editing of a window by different users, including generating a source window that can run the logic, a position window that can control the positioning, and a render window that can render output based on the source window and the position window.

### CROSS-REFERENCE TO RELATED APPLICATIONS

This application claims priority to U.S. Provisional Application Ser. No. 61/874,295, filed Sep. 5, 2013, entitled “SYSTEM AND METHOD FOR DECOUPLING DESKTOP WINDOWS IN A MULTIPLE DESKTOP ENVIRONMENT”, the disclosure of which is hereby incorporated herein by reference in its entirety for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

1. Field of Invention:

Embodiments of the present invention are generally related to computer systems and user-computer interactions, and are in particular related to systems and methods for decoupling windows from the desktop it was created on in a multiple desktop environment.

2. Background:

A traditional computer is equipped with a desktop confined to the size of all monitors attached to the computer. The computer desktop is traditionally organized in layers of objects—typically referred to as windows, applications or widgets. A window can e.g. be moved, resized and modified freely anywhere on the computer desktop. However the window is limited to the specific desktop it is created on and cannot move freely from one computer desktop to another computer desktop. With an embodiment of the present invention a window can be decoupled from the desktop it originate from and move freely to any other computer desktop.

Today's technology such as e.g. X Window System an application or a window can have its logic running on one computer while receiving input from a second computer. With this a first computer can e.g. request a second computer to create an output window based on logic running on the first computer. However the output window created on the second computer cannot be moved from the second computer to a third computer. In the event a user would like to have an output window on a third computer, the third computer will need to be linked to the first computer that then request the third computer to create an output window. While technologies such as X Window System offer some flexibility in terms of separating logic from input/output windows it does not offer a complete free move of e.g. a window created on one desktop to move to another desktop.

Today e.g. a web page can exist on the computer desktop it was created on, if a first user would like to hand over the web page to a second user on a different desktop, the first user would typically send a link to the second user with e.g. email or instant messaging. The second user would then open the received link in a new web browser on the second user's computer desktop and start a new independent instance of the webpage. In the event the first-user would like to share a document or a spreadsheet the first user will need to e.g. send a file the second user then opens on the second user's desktop. An alternative to sending a file is for the first user to allow the second user access to a cloud based document or spreadsheet, where both users can access and modify the document from a browser. However in this cloud based solution the document/spreadsheet is located on a server and accessed through a browser on the computer desktop and thus no windows or applications are moved from one desktop to another, they are simple accessed from more than one desktop.

Regardless of which known technology is used there are several steps from a first user providing a second user with a copy of an object such as an application or a window originating on first user's Desktop. An embodiment of this invention will eliminate these unnecessary steps by allowing a first user to move any kind of e.g. a window from one Desktop to another Desktop—either as a copy that can be linked to or independent of the objects state. By cutting out none value added steps in an information sharing process the access to current information will be quicker.

In e.g. a networked operation center a dispatcher can with an embodiment of the present invention quickly move critical information from his/her computer desktop to e.g. a co-worker that can take action instantly based on the information received regardless if that co-worker is in the same geographical area or e.g. is on-site handling an emergency situation.

### SUMMARY

Described herein are systems and methods decoupling Windows from the Desktop it was created on in a multiple Desktop environment. With this present invention a Window created on one Desktop can be moved to another Desktop where a second user can interact with the Window created on the first Desktop. In an embodiment a Window can be separated into e.g. a Source-Window that can run the logic, a Position-Window that control the positioning and a Render-Window that can render output based on Source-Window logic and the Position-Windows' position. This method can allow e.g. Windows to move from one Desktop to another regardless where the Window was first created.

In an embodiment a Window can move freely between Desktops including System-Desktops, where a Desktop can be confined as the area of monitors attached to a computer and a System-Desktop can be confined as the area of monitors attached to a set of computers. In an embodiment a Window can move freely between any Desktop within e.g. a defined Group of computers. A Desktop and System-Desktop can also be unlimited in size where the monitor's physical layout is taken into account when rendering section(s) of the unlimited desktop.

In an embodiment a user can e.g. view a section of a Desktop, an entire Desktop or several Desktops simultaneously depending on how the user arrange Views of Desktops within the Group regardless of which computer defines the desktop. In an embodiment the user can be able to interact, move and resize any Window that is in view regardless which Desktop the Window was created on or resides at.

In an embodiment a user can e.g. navigate between Views, follow live rendering of other users activities and split Views into sections that can be moved, resized and deleted based on user's current needs.

### BRIEF DESCRIPTION OF THE FIGURES AND TABLES

FIG. 1 show an example of high-level components of an embodiment.

FIG. 2A shows an example of a sequence diagram for how to create Views.

FIG. 2B shows an example of ownership and roles of Source, Desktop and View.

FIG. 3A shows an example of relations between the Source-Windows, Position-Windows and Render-Windows.

FIG. 3B shows an example of ownership and roles of Source-Windows, Position-Windows and Render-Windows.

FIGS. 4 to 8 shows an example of a step by step process for handling Windows and Views between computer Desktops.

FIG. 9 shows an example of interactions between computers in a Group.

FIG. 10A shows an example of a centralized model of a system.

FIG. 10B shows an example of ownership and roles in a centralized model.

FIG. 11A shows an example of a distributed model of a system.

FIG. 11B shows an example of ownership and roles in a distributed model.

FIG. 12 shows an example of a Navigation-Window from a Desktop perspective.

FIGS. 13 to 15 shows an example of a step by step process for moving between Views.

FIGS. 16 to 18 shows an example of a step by step process for moving a Window from one View to another.

FIG. 19 shows an example of a Navigation-Window from a monitor perspective.

FIGS. 20 to 22 shows an example of a Peephole-Window.

FIGS. 23 to 25 shows an example of a step by step process for creating a Linked-Window using a Peephole-Window.

FIGS. 26 to 27 shows an example of a step by step process for creating a new instance of a Window using a Peephole-Window and m-Sync.

FIG. 28 shows an example of using Peephole-Window to change a View.

FIGS. 29 to 38 shows an example of a step by step process for splitting and deleting Views.

FIGS. 39 to 41 shows an example of a step by step process for splitting a View into multiple Views.

FIG. 42 shows an example process describing the interactions between a Position-Window, a Render-Window, and a Source Window in accordance with various embodiments.

### DETAILED DESCRIPTION

Described herein are systems and methods decoupling Windows from the Desktop it was created on in a multiple Desktop environment. With this present invention a Window is not tied to the Desktop it originates from but can be moved freely between Desktops within e.g. a Group of computers and/or system(s) of computers that act as one combined Desktop. In addition with this present invention a user can e.g. interact with a Window, where the Window can be rendered at the first users computer, but it's Position-Window can be located on a second computer and the logic can be running on a third computer. Furthermore multiple users can e.g. interact with the same Source-Window simultaneously through e.g. multiple Render-Windows and Position-Windows where user can be spread over geographically distances or located in the same room.

In an embodiment a Desktop can e.g. be defined as the area of monitor(s) attached to a computer and it can be defined as e.g. a System-Desktop, where multiple computers can have a combined set of monitors attached that together define a Desktop area. A Desktop and System-Desktop can also be unlimited in size where the monitor's physical layout is taken into account when rendering section(s) of an unlimited desktop. A user can then View any Desktop within a defined Group of Desktops or a section of one or more Desktops or have a view of all Desktops or any combination there off. In an embodiment a user can e.g. move and interact with any Window that is within the users View regardless which computer or Desktop the Window is created on or currently residing at and regardless which Desktop the user is viewing. For example a user can View a section of a Desktop that is in another geographically location where the Window in View is sourced from a third location. The user can in an embodiment create new Views and modify existing Views to best serve the users need for e.g. interaction and information gathering and with this offer the user new levels of computing flexibility.

In an embodiment multiple users can e.g. each have a View of the same Desktop, where a Render-Window can be located on each user's local View and Position-Window(s) can e.g. be located on the same or different computer(s) and the Source-Window on e.g. one of the users' computer—and where one Position-Window can be linked to several Render-Windows. In an embodiment this present invention can allow multiple users to interact with the same Window simultaneously, where e.g. logic can be shared but position, size and scale can be independent. In an embodiment multiple users can e.g. interact with a linked copy of a Window, where each interaction will be reflected on all versions of the Window. For example if first user scrolls content on a webpage the page is scrolled for all users with the webpage in View. However if first user in the example moves the webpage, it will only move for the first user and have no impact on other users. In this scenario the user create a new Position-Window that is linked to the Source-Window. In another example first user can create a completely new instance of the Window including a new Source-Window instance and in this case first user can scroll the webpage and it will only scroll for the first user.

In an embodiment multiple users can create one or more Views of Desktops within a Group, where each user can navigate between Desktops and create/delete Views dynamically. For example a user can have a Navigation-Window that show Desktops in a Group and where the user can see which Desktops or sections of Desktops other users in the Group is viewing. In an embodiment a first user can create Views and move between Views based on the user's needs e.g. for collaboration or information sharing purposes. For example a Navigation-Window can render live feeds of Desktops and Views within a Group where each user e.g. can follow what other users are viewing. This can for example be practical in a set-up where a supervisor is training an employee and e.g. follow along as the employee is performing the assigned task where the supervisor is capable of “looking over the shoulder” without directly engaging unless needed. In the event the supervisor e.g. need to engage then the supervisor can move to the employees View and see what the employee is seeing as well as guide and interact with the Windows in View. In another example a teacher can follow along as students perform exercises or e.g. group work without directly guiding their work process and only step in if the teacher finds it necessary.

In an embodiment a Navigation-Window can be used to move Windows between Desktops or sections of Desktops. Where a user e.g. can move a Window from the user's Desktop to e.g. a large display wall for information sharing and collaboration purposes. For example a teacher can prepare information on the teachers Desktop and use a Navigation-Window to move the Window to a digital whiteboard where students can see it. The students could then move a copy of the Window to their own Desktop for further exploring or performing specific tasks. In this scenario a teacher has the option to provide some students with one type of Window e.g. documents and another type of Window to another group of students e.g. another document or a webpage; ask the students to explore the content and create a report summarizing their findings. The students would then be able to move Windows with their content e.g. a presentation to a digital whiteboard from their Desktop. All this is done without emailing attached files between the users.

In an embodiment a Peephole-Window can allow a user such as e.g. a teacher or a supervisor to see and follow what e.g. a student is doing. Where a Navigation-Window with live rendering could be bitmaps of Windows a Peephole-Window could be linked to a View with meta-data describing the Window(s) in the Peephole-Window. A Peephole-Window could offer additional detail and options to interact with Windows rendered in the Peephole-Window that lies beyond live feeds from a navigation method. Meta-data could include e.g. link to Source-Window, Position-Windows, where a user for example can create a copy of a Window in the Peephole-Window and move it to the users own View and continue to work either in collaboration with or independently from the first user. For example a user can have a Peephole-Window with a Window where a co-worker is working on something related to the user—it could e.g. be the first user is working on product requirements for a new product while the second user is reviewing the competition for that product; using a Peephole-Window both users can receive current updated status from each other and follow along as the other user makes progress. In this scenario the Peephole-Window is used for current updated information sharing. First user can for example create a linked copy of the Window in the Peephole-Window and use the second user's data in the first user's report, when it fits the first user without interrupting the second user. In this scenario the second users work is used in the first users work and the Peephole-Window provide the first user fast access and current updates that can be integrated into the first users work at any given time. In a similar scenario the first user could take over work from the second user and continue where the first user let go by e.g. using the Peephole-Window to create a Linked-Window copy of the first user's Window. In the last example a company can take advantage of employees around the globe, where one employee hand over the work to the next employee as the first employee e.g. finish the workday and the next employee starts the workday.

In an embodiment a Peephole-Window can be used to jump between views as an alternative or supplement to the Navigation-Window, where e.g. it can be easier for a teacher who is following a student through a Peephole-Window to use the Peephole-Window in order to jump to the same View as the student has and provide help; while the teacher might choose the Navigation-Window for a student that does not necessary need the same degree of supervision and help.

In an embodiment a View can be split and resized based on the user's needs. A split of a View can e.g. mean one View is split into two, where the user can e.g. use the second View to access another Desktop while keeping the original View of the first Desktop in the first view. A user can split Views into as many sections as the user need and resize any of the sections to optimize the current needs; as well as change Views as needs changes over time. In an embodiment a user can move Windows from one View to another by moving across a divider as an alternative to using a Navigation-Window or a Peephole-Window. Where a move of Windows using a Peephole-Window or Navigation-Window is useful for moving Windows between different users, a move across a divider of Views can be useful when the user would like to move Windows between the users own Views. For example a user creates two Views that the user looks at simultaneously, e.g. in a monitoring situation where the first View have a set of Windows rendering video cameras from the building and a second View is the work area where the employee can pull Windows in based on incidents found in the first View. In this example a user can have Views based on e.g. locations that the user is monitoring, where different buildings in the same area could be in one View, different sections of one building in another View and different buildings in different geographical areas in a third View etc. Splitting Views can be an efficient way for a user to supervise many Windows or many users simultaneously e.g. in a supervisor situation where a teacher could have a View of each students Desktop. Splitting Views can also be a logical way to organize content/Windows for a user that has access to multiple Desktops and/or large Desktop areas such as e.g. display walls.

The use case examples for this present invention are many and can apply to many different industries. For example operation centers for monitoring purposes and access to data sharing based on incidents as they occur. Another example is classrooms where teachers can choose when to interact with the entire class and when to guide on individual levels. A third example is business collaboration situations where e.g. employees spread across geographical distances can collaborate and share current information by using Views and moving Windows freely between computers & Desktops within the company.

An embodiment of this present invention can mean that a user can eliminate none value adding steps that the user has to do today in order to share Windows with other users. For example with the present invention a first user can move a Window to a second user as part of a conversation by simply moving the Window or a copy of the Window from the first users View to the second users View. Using today's technology the first user would need to either send a link or a file to the second user, wait until the second user receive the link/file and have had a chance to open the link/file, then the first user will typically need to guide the second user to the section of the content that the first user would like the second user to look at. Alternatively the two users could login to a remote desktop session where the first user can share his/her desktop. However that does not move the content to the second user and still require the users to spend time on logging into a remote desktop session. These steps are far more complicated and time consuming than for the first user to simply move the Window to the second user, and where the second user instantly has the position of the Window in View that the first user would like to share.

An embodiment of this present invention can in business collaboration situations mean a virtual Desktop is created for e.g. project work or presentations. Any user with rights to access the virtual Desktop can move or copy any of their own Windows to/from the virtual desktop where they collaborate with other employees around a project or presentation. Using Views, any user can work simultaneously on their own Desktop while working, viewing and contributing to the virtual Desktop rendered in another View on the users monitors.

### Glossary

In accordance with an embodiment, the following terms are used herein. In accordance with other embodiments, different and/or other terms can be used:

A “Desktop” refers to the placement, size and layer of a collection of objects where each object has a position relative to the same arbitrary origin on the Desktop.

A “System-Desktop” refers to a set of computers that together define one Desktop.

A “System-Client” refers to a piece of software running on a computer that is part of a System-Desktop and linked to a System-Server.

A “System-Server” refers to a piece of software running on a computer that is part of a System-Desktop and responsible for the list of Windows on the Desktop and their z-index and position on the Desktop.

A “System-Position-Client” refers to a piece of software running on a computer that is part of a System-Desktop and linked to a System-Position-Server.

A “System-Position-Server” refers to a piece of software running on a computer that is part of a System-Desktop and responsible for the list of Windows on the Desktop and their z-index, but not the positions of the Windows on the Desktop.

A “Group” refers to a collection of computers running compatible software.

A “View” refers to an area of a monitor that renders an area of a Desktop. The computer which the monitor is connected to does not have to own a Desktop in order to create and render a view. The viewed Desktop does not have to reside on the same computer as the monitor.

A “Source” refers to a piece of software running on a computer responsible for launching and executing one or more Source-Windows on this computer.

A “Window” refers to an object occupying a defined area that can but is not restricted to a rectangular shape. A Window takes input from the user and renders output based on the Windows logic.

A “Position-Window” refers to the position and z-index of a Window on a specific Desktop. A Position-Window is linked to one Source-Window and will control the position & z-index for zero or more Render-Windows.

A “Source-Window” refers to the logic of a Window including size and shape of the Window's area. A Source-Window is controlling the size and shape of at least one Position-Window and the size and shape and rendered content of zero, one or more Render-Windows.

A “Render-Window” refers to the rendering of a Window inside a specific View. The Render-Window reports user input for position & z-index to the linked Position-Window and content input to the linked Source-Window.

A “Linked-Window” refers to a situation where two or more Position-Windows are linked to the same Source-Window. Linked-Windows shares the same Source-Window and have different Position-Windows.

A “Navigation-Window” refers to a Window placed inside a View on top of the Desktop Windows the View is rendering without belonging to the viewed Desktop. A Navigation-Window can render all Desktops in the Group this computer belong to, and can illustrate the section of any Desktop viewed by any users in the Group. In addition a Navigation-Window can show a thumbnail of live feeds of the Desktops in the Group.

A “Peephole-Window” refers to a window that renders the same area as the View it is linked to and has a position inside another View without belonging to the Desktop viewed by the View it is positioned in, where the proportions/shape of the Peephole-Window is controlled by the linked View. The Peephole-Window may contain meta-data about the Windows rendered inside the Peephole-Window that allow various scenarios of copying and instantiation of Windows based on user input to the Peephole-Window.

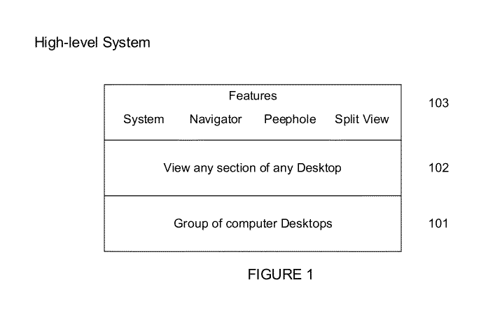

FIG. 1 shows an example of high-level components for this present invention. In an embodiment more than one Desktop can be organized in a Group of Desktops (101), where multiple users can access any Desktop or section of Desktop through Views (102). In addition this present invention include a set of features (103) that a user can utilize for accessing and operating Views of Desktops. In an embodiment one feature is a System-Desktop, where a set of computers define a System-Desktop. Another feature is a Navigation-Window that serves as a tool for a user to navigate between Views on multiple Desktops. In addition a Peephole-Window is a feature, where a user can follow another user's activities more closely. And furthermore in an embodiment a user could split Views into new Views or sections of Views in order to organize, what the user is looking at in situations such as e.g. monitoring multiple areas of the same or different Desktops simultaneously.

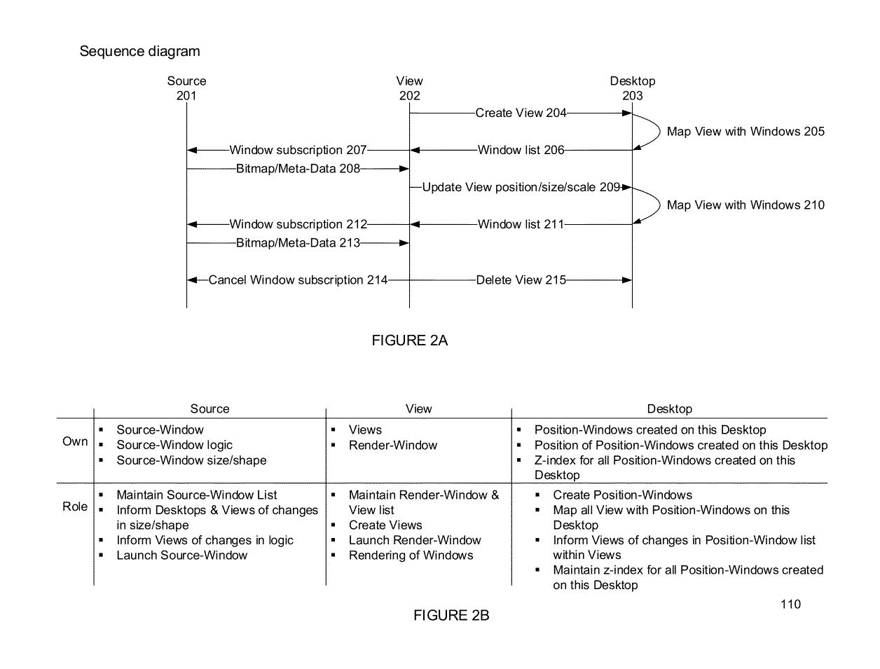

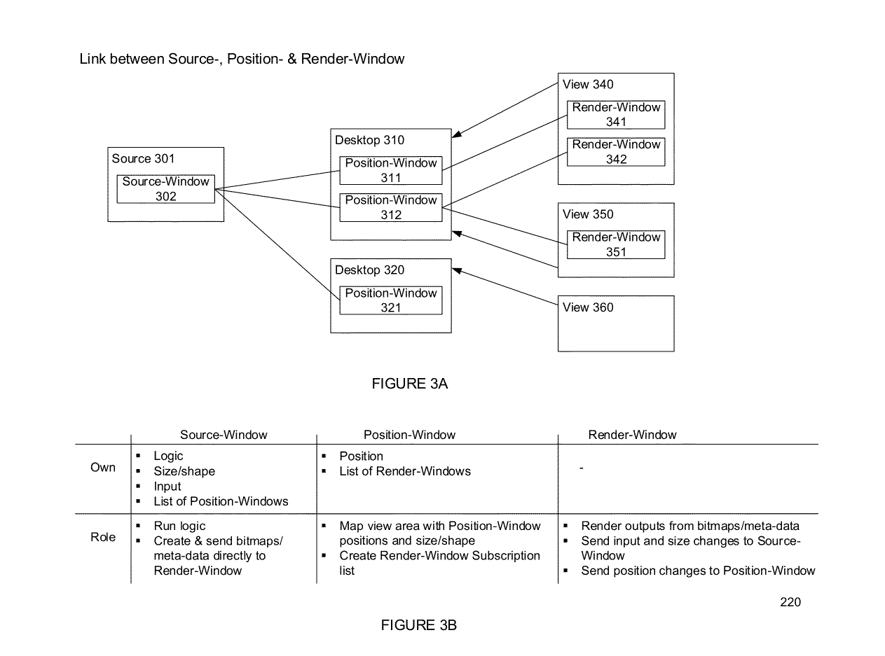

FIG. 2A shows an example of a sequence diagram of how a View can be created in an embodiment, where roles and responsibilities are divided into Source (201), View (202) and Desktop (203). In an embodiment View (202) creates a View (204) with size and position of the new View to Desktop (203). Desktop (203) then map View area with Window(s) that could be in View (205) and send a Window list (206) to View (202) containing all Windows that has an overlapping area with the defined View's area. View (202) then send a Window subscription request (207) to Source (201) in order to receive output(s) from Source-Window(s) that are within the View area. Source (201) can send bitmap(s)/meta-data (208) for any Window that is on the Window subscription list (207). In the event View (202) update position, size and/or scale of a View (209) the update can be send to Desktop (203) in order to map the updated View's position/size/scale (209) with exiting Window(s) (210). Similar to the first mapping (205) Desktop (203) return a Window list (211) based on the updated View's position/size/scale (209). View (202) can in an embodiment when it receives a Window list (211) from Desktop (203) send Window subscription(s) (212) to Source (201) for all Windows that are within the updated View. Source (201) can then similar to the first situation create and send bitmap(s)/meta-data (213) based on the new Window subscription (212). A bitmap(s)/meta-data (213) can be send for each time Source (201) has update(s) of the Window(s) in View. When View (202) closes a View, it sends a “delete View” notification (215) to Desktop (203) and a “cancel Window subscription” (214) notification to Source (201).

FIG. 2B is a continuation of FIG. 2A and shows an example of how roles and ownerships can be defined for Source, View and Desktop (110). In an embodiment Source would own zero, one or more Source-Windows, the logic and size of each Source-Window; View would own all Views and Render-Windows; and Desktop would own all Position-Windows created on this Desktop, the position of each Position-Window created on this Desktop and the z-index for all Position-Windows created on this Desktop. In an embodiment a Source would have the role of maintaining a list of Source-Windows, informs Desktop and View about changes in Source-Window(s) size as well as changes in logic. In addition Source would be responsible for launch of Source-Window(s). In an embodiment View would have the role of maintaining a list of Render-Windows and Views; it would create new Views, launch Render-Window(s) and render the Render-Window(s) in View. In an embodiment Desktop would have the role of creating Position-Window(s), map Views with Position-Windows on this Desktop, inform Views of changes in Position-Window list within View(s); and maintain z-index for all Position-Windows created on this Desktop.

FIG. 3A shows an example of the link between Source-Window, Position-Window and Render-Window as well as how each Window component is linked to Source, Desktop and View. In an embodiment a Source-Window (302) is owned by a Source (301), a Position-Window (311) is owned by a Desktop (310) and Render-Window (341) is owned by a View (340). A Desktop (310) creates one or more Position-Windows (311, 312) on this Desktop (310). Each Position-Window (311, 312) is linked to a Source-Window (302) that is owned by a Source (301). In an embodiment a View (340) creates one or more Render-Windows (341, 342) and link a Render-Window (341) to a Position-Window (311). In addition a View (360) is a View of a Desktop (320), where the Desktop (320) has a Position-Window (321) that is linked to a Source-Window (302) but where the Position-Window (321) is not within the View area (360) even though it is located on the Desktop (320) that View (360) is viewing. In this event View (360) is not going to create any Render-Window. In an embodiment more than one View (340, 350) can View a Desktop (310) and more than one Render-Window (342, 351) can be linked to the same Position-Window (312). In an embodiment a View is linked to one Desktop, where a Desktop can be linked to none, one or many Views and a Render-Windows on a View is linked to one Position-Window on the Desktop. In this example a Position-Window can be linked to none, one or many Render-Windows, where a Render-Window is linked to one Source-Window located on a Source and Source-Window can be linked to none, one or many Render-Windows. The collection of Render-Windows inside a View can therefore link to none, one or several Sources that in turn will have none, one or several Source-Windows.

FIG. 3B is a continuation of FIG. 3B and shows an example of ownership and roles for a Source-Window, Position-Window and a Render-Window (220). In an embodiment a Source-Window owns the logic, size/shape, input handling to the Source-Window as well as a list of all Position-Windows linked to this Source-Window. A Position-Window owns the position of this Position-Window and a list of all Render-Windows linked to this Position-Window. In an embodiment a Render-Window will not necessary own anything specific because of its role is to: render output e.g. bitmap or meta-data from the Source-Window it is subscribing to, send input received for this Render-Window, send Render-Window size change request to the Source-Window it is subscribing to; and send position change request of this Render-Window to the Position-Window this Render-Window is linked to. In an embodiment a Source-Window has the role of running its logic, create and send bitmaps/meta-data directly to each Render-Window that subscribes to the Source-Window. In an embodiment a Position-Window have the role of mapping View area with this Desktops' list of Position-Windows and their position and size/shape as well as create a Render-Window list that is send to View.

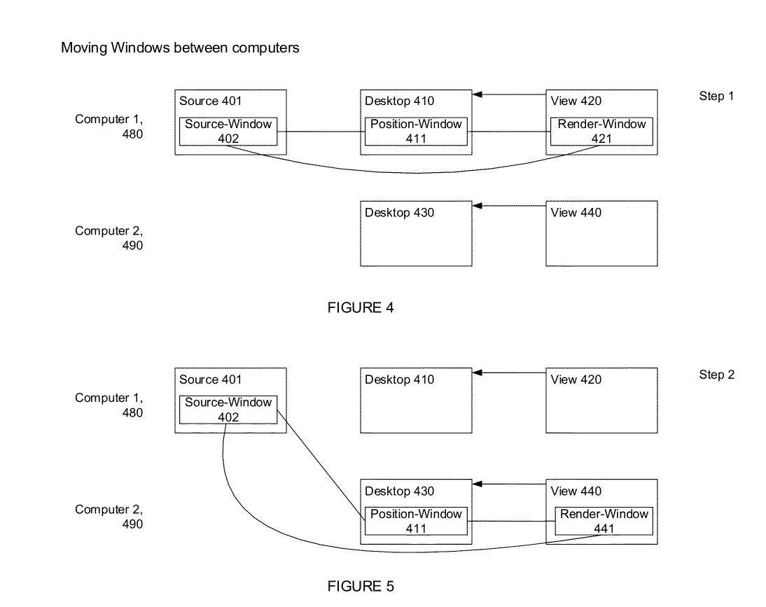

FIG. 4 shows an example of how Source-Window, Position-Window and Render-Window are linked across computers. In an embodiment a Source-Window (402) is created by a Source (401) on computer 1 (480). On this computer (480) a Desktop (410) has created a Position-Window (411) that is linked to the Source-Window (402). In addition a View (420) is created of the Desktop (410) and because the Position-Window (411) is in view, a Render-Window (421) is created and linked to this Position-Window (411). In addition the Render-Window (421) is subscribing to the Source-Window (402) the Position-Window (411) is linked to. Computer 2 (490) has a Desktop (430) where a View (440) is created of that Desktop, but unlike computer 1 (480) no Source-Window, Position-Window or Render-Window is created on computer 2 (490).

FIG. 5 is a continuation of FIG. 4 and show an example of how a Position-Window can be moved from one computer to anther computer. In an embodiment Position-Window (411) has moved from computer 1 (480), Desktop (410) to computer 2 (411) Desktop (430). In this scenario the move means that View (440) now has the moved Position-Window (411) in View and therefore creates a new Render-Window (441). In this example the Position-Window (411) will still be linked to the original Source-Window (402) even though the Position-Window (411) has moved to computer 2 (490) and the Source-Window continues to be located on computer 1 (480). In addition Render-Window (441) requests a subscription to Source-Window (402) for updates. In this example the Source-Window (480) is located on computer 1 (480) while Position-Window (411) and Render-Window (441) is located on computer 2 (490). In an embodiment View (420) can still view Desktop (410), however in the case where the Position-Window (411) no longer is in view (420), the Render-Window (421) is deleted and the subscription to Source-Window (402) for this Render-Window (421) is canceled.

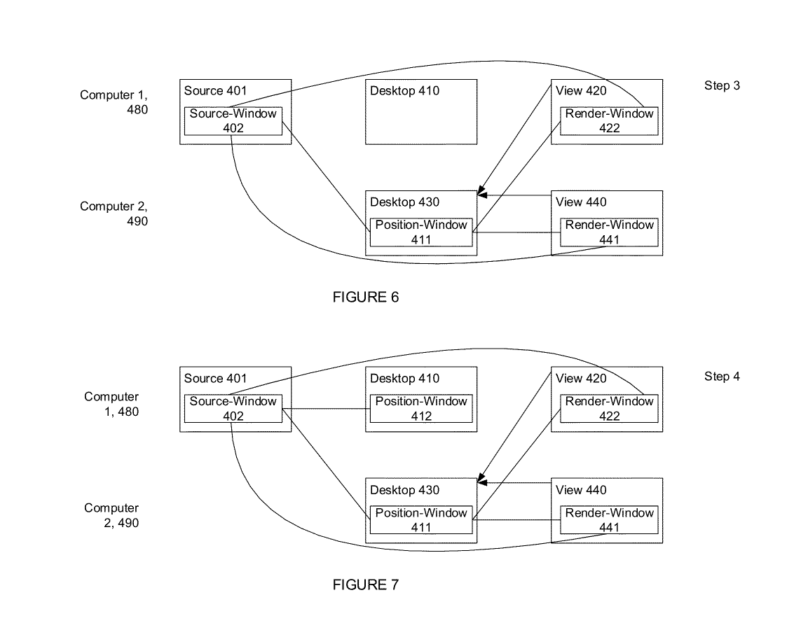

FIG. 6 is a continuation of FIG. 5 and show an example of how a View can be created of a different Desktop on another computer. In an embodiment View (420) is linked to Desktop (430) even though Desktop (430) is located on another computer (490) than View (420). In this example Position-Window (411) located on Desktop (430) is in view of View (420), this means that View (420) creates a Render-Window (422) that is linked to Position-Window (411) and because Position-Window (411) is linked to Source-Window (402) Render-Window (422) request a subscription to Source-Window (420) for updates and bitmaps. In this scenario the Source-Window (402) and the Render-Window (422) is located on the same computer (480), while the Position-Window (411) they are linked to is located on a different computer (490). In addition the scenario shows how one or more Render-Windows (422, 441) can be linked to the same Position-Window (411) and how one or more Views (420, 440) can be linked to the same Desktop (430).

FIG. 7 is a continuation of FIG. 6 and show an example of how a Source-Window can have more than one Position-Window linked. In an embodiment a Position-Window (411) on Desktop (430) is copied to Desktop (410) by creating a new instance of Position-Window (412) on Desktop (410). In this example the copied Position-Window (412) is linked to the same Source-Window (402) as the original Position-Window (411). In addition the copied Position-Window (412) is copied to Desktop (410) on computer 1 (480), while the original Position-Window (411) remains located on Desktop (430) on computer 2 (490). In this example the View (420, 440) is not impacted by the copy of the position-Window because none of the Views (420, 440) is viewing Desktop (410), where the new Position-Window (412) is created.

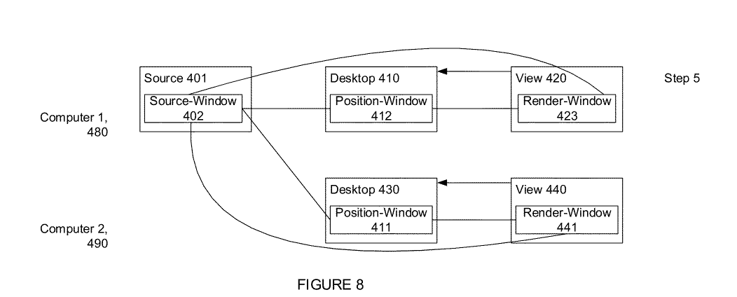

FIG. 8 is a continuation of FIG. 7 and show an example of how Render-Windows and Position-Windows located on different computers can be linked to the same Source-Window. In an embodiment View (420) is a view of Desktop (410) on computer 1 (480) and because Position-Window (412) is in view of View (420) a Render-Window (423) is created. The Render-Window (423) is linked to Position-window (412) and subscribe to Source-Window (402), where all three Window components (423, 412, 402) is now located on the same computer—computer 1 (480). In an embodiment View (440) is a view of Desktop (430) and because Position-Window (411) is located on Desktop (430) and within View (440) a Render-Window (441) is linked to this Position-Window (411). Desktop (430) with Position-Window (411) and View (440) with Render-Window (441) are located on computer 2 (490). In addition Position-Window (411) is linked to Source-Window (402) on computer 1 (480) which in this example means that Render-Window (441) is subscribing to Source-Window (402).

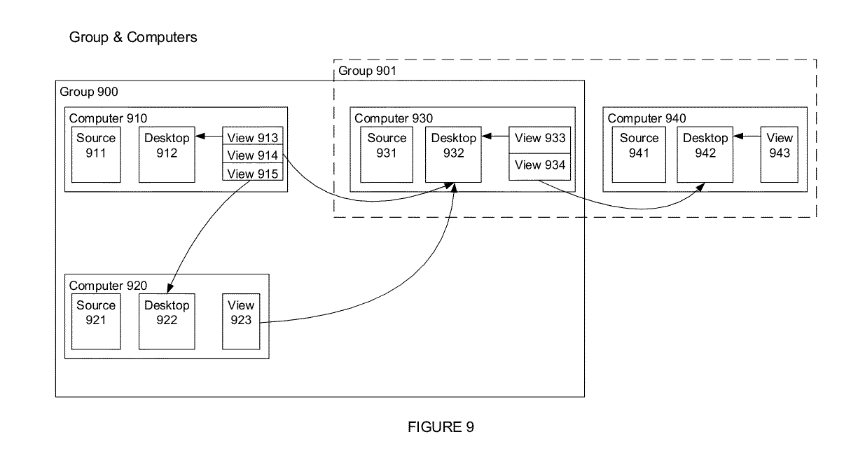

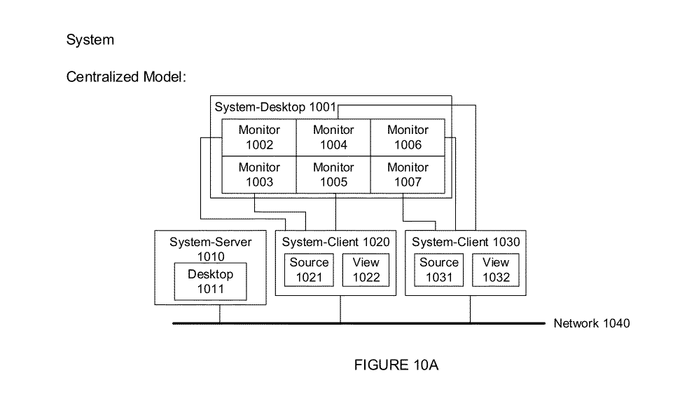

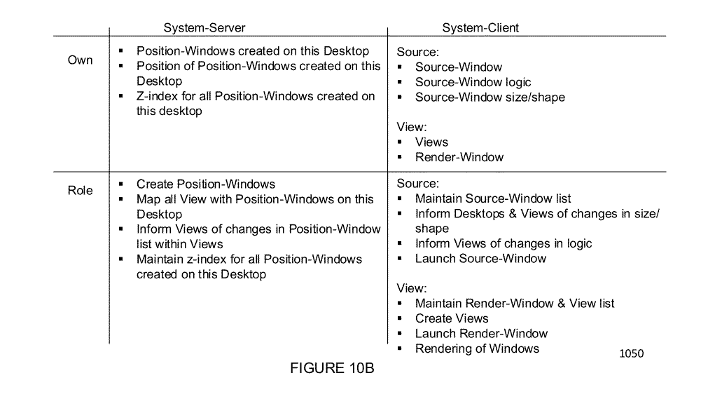

FIG. 9 shows an example of how computers can be grouped. In an embodiment a Group of computers (900) include computer (910, 920 and 930), where computer (930) also is included in another Group (901) together with computer (940). In this example one computer (930) is part of two different Groups (900, 901), this means computer (930) could View any Desktop (912, 922, 932, 942) within one of the two Groups (900, 901), where e.g. computer (910) can View any Desktop (912, 922, 932) in Group (900). In an embodiment a computer can View any Desktop that is in the same Group as the computer and a Group can add and delete computers within the Group dynamically. Each computer in a Group can own all configuration data of this computer. However properties of the monitor a Render-Window is rendered on could be made known to the Source-Window that the Render-Window subscribes to in order to handle e.g. efficient bitmapping. In an embodiment computer (910) can have for example three Views, where one View (913) is a View of Desktop (912) on computer (910), while View (914) is a View of Desktop (932) on computer (930) and view (915) is a View of Desktop (922) on computer (920). In this example computer (920) has a View (923) of Desktop (932) located on computer (931), while computer (930) has a View (933) of its own Desktop (932) as well as a View (934) of Desktop (942) on computer (940) that is part of Group (901). In this scenario computer (920) cannot view Desktop (942) on computer (940) because they do not belong to the same Group. In an embodiment a computer can open, move and modify any Window within the Group it belong to, while a computer Desktop own Position-Window on this Desktop regardless of who created the Position-Window; where a Source own all Source-Windows running on this computer regardless where the Source-Window is viewed from; and a View owns all Views created by this computer regardless of which Desktop it Views.

FIG. 10A shows an example of a centralized model of a System-Desktop. In an embodiment a System-Desktop (1001) can consist of a set of monitors (1002, 1003, 1004, 1005, 1006, 1007), where a System-Client (1020) is running a set of the monitors (1002, 1003, 1005) and another System-Client (1030) is running another set of monitors (1004, 1006, 1007) and where a System-Server (1010) in this scenario is not running any monitors. However each System-Client can run one or more monitors while the System-Server can run none, one or more monitors. The System-Server (1010) and System-Clients (1020, 1030) can be connected through a computer network (1040). In an embodiment a System-Server (1010) can be responsible for the System-Desktop (1011), while each System-Client (1020, 1030) can be responsible for Source (1021, 1031) on this System-Client and View (1022, 1032) created by this System-Client. In an embodiment a System-Desktop differs from a traditional Desktop by having a system of computers to run one Desktop.

FIG. 10B is a continuation of FIG. 10A and shows an example of ownership and roles for a System-Server and a System-Client in a centralized model of a System-Desktop (1050). In an embodiment a System-Server can own the System-Desktop and with that the Position-Windows created on this System-Desktop, regardless of which section on the Desktop the Position-Window is created on. In addition the System-Server can own positions of all Position-Windows on this System-Desktop as well as the z-index of all Position-Windows created on this System-Desktop. In an embodiment a System-Client can own Source and View, where each System-Client own Source including Source-Window, logic and size on this System-Clients area of the System-Desktop as well as Views and Render-Windows on this System-Clients area of the System-Desktop. This means that in a centralized model of a System-Desktop, the Source and Views can be distributed while the Desktop is centralized. In an embodiment a System-Server can keep all System-Clients updated about Position-Windows, their positions and z-index with the purpose of having a floating System-Server, where in the event the dedicated System-Server is unavailable for the system, another computer in the system is capable of taking the role as System-Server automatically.

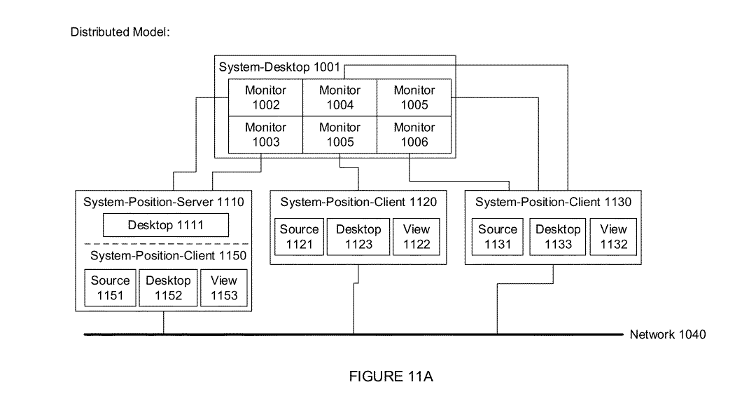

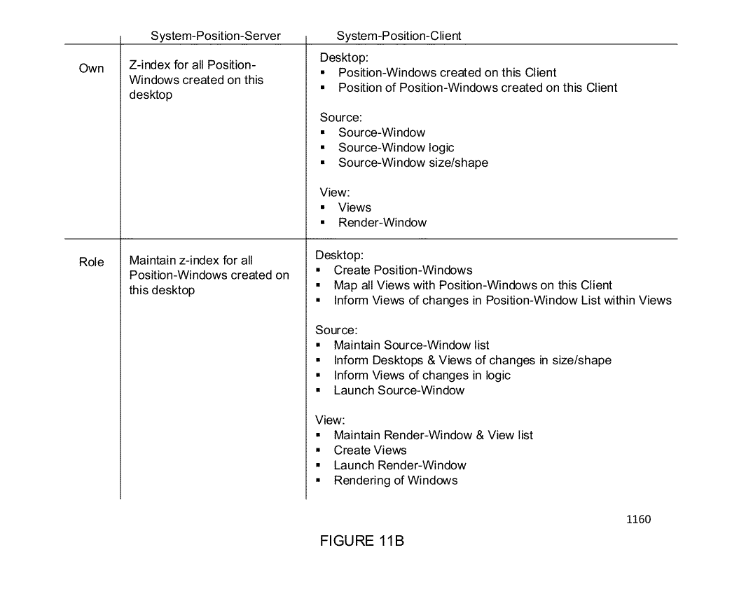

FIG. 11A shows an example of a distributed model of a System-Desktop. In an embodiment a distributed model of a System-Desktop means that the System-Desktop is split into two separate roles—one Desktop section (1111) that handles e.g. z-index of all Position-Windows on this System-Desktop run by a System-Position-Server (1110) and another Desktop section (1152, 1123, 1133) that handles positions and creation of Position-Windows run by each System-Position-Client (1150, 1120, 1130). The System-Position-Server (1110) can in this example be located on the same computer as a System-Position-Client (1150). In an embodiment a System-Position-Client (1120, 1130, 1150) can be responsible for Source (1121, 131, 151) and View (1122, 1132, 1153) as well as some parts of Desktop (1123, 1133, 1152) associated with this System-Position-Clients Desktop area. In an embodiment the advantage of a distributed model of a System-Desktop is movement of a Window rendered on the same View as the computer hosting the Position-Client may not require as frequent updates of the windows position to the other System-Position-Clients in the system as nothing is rendered on their views. The less network traffic being send, the larger a system can be built without running into network bandwidth limitations. The benefit of sharing the Position-Window's position with the other System-Position-Clients is to allow the Position-Window to remain present even if its System-Position-Client should fail and disconnect from the network. In that case any other of the System-Position-Clients can take over as owners of the Position-Window.

FIG. 11B is a continuation of FIG. 11A and shows an example of ownership and roles for a System-Position-Server and a System-Position-Client in a distributed model of a System-Desktop (1160). In an embodiment of a distributed model of a System-Desktop a System-Position-Server can own the z-index for all Position-Windows created on this System-Desktop. In addition a System-Position-Client in a distributed model can own all Position-Windows created on this System-Position-Clients System-Desktop area as well as the position of all Positions-Windows created on this System-Position-Client System-Desktop area. Furthermore in an embodiment a System-Position-Client can own Source such as Source-Window, Source-Window logic and Source-Window size/shape for this System-Position-Client area of the System-Desktop. In an embodiment a System-Position-Server have the role of maintaining z-index for all Position-Windows created on this System-Desktop regardless of which area of the System-desktop the Position-Window was created at. The System-Position-Client have the role of creating Position-Windows, map all Views of the Desktop with Position-Windows on this System-Position-Client area and inform Views of changes in Position-Window list within each View, where the role can be limited to the System-Position-Clients area of the System-Desktop. In addition the System-Position-Client can have the role of maintaining Source such as e.g. maintain Source-Window list, inform Desktops and Views of changes in Source-Window size/shape, launch Source-Windows on the section of the System-Desktop the System-Position-Client is responsible for. The System-Position-Client can furthermore maintain Views e.g. maintain Render-Window and View list, create Views, launch Render-Windows and rendering of Render-Windows on the section of the System-Desktop the System-Position-Client is responsible for. In a distributed model the roles and ownership of Source, Desktop and View are distributed to each System-Position-Client, where this System-Position-Client is responsible for a defined area of the System-Desktop—with the exception of the z-index of Position-Windows that is handled by a centralized System-Position-Server for this System-Desktop in order to handle conflicts. Similar to the centralized model described in FIG. 10B a System-Position-Server is a role that can be floating and assigned dynamically by the system based on computers availability in the system.

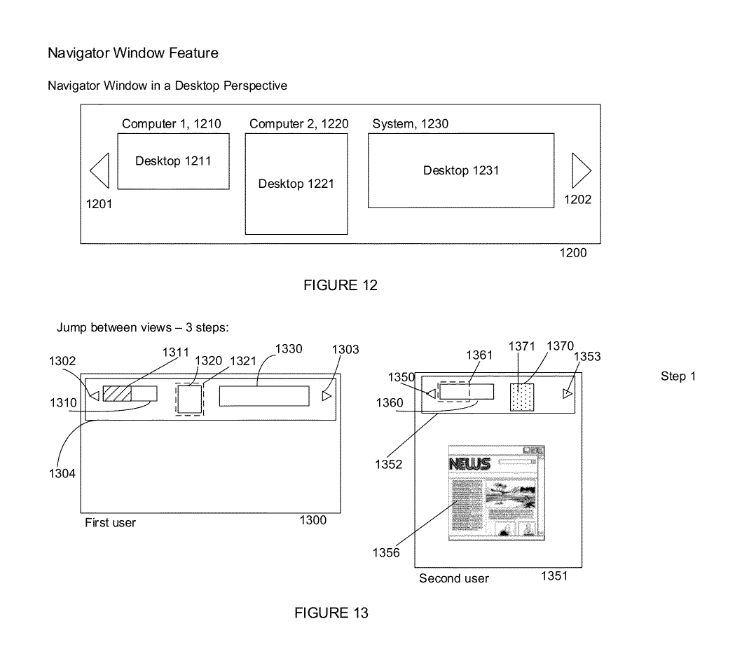

FIG. 12 shows an example of a Navigation-Window from a Desktop perspective. In an embodiment a Navigation-Window (1200) can be a useful way for a user to navigate between Desktops as well as see which Desktops or section of Desktops other users are viewing. In this example a computer 1 (1210) owns Desktop (1211), computer 2 (1220) owns Desktop (1221) and system (1230) owns System-Desktop (1231), each Desktops size and relative position can be visualized in the Navigation-Window (1200). The Navigation-Window can show all Desktops within the Group. In the event the Navigation-Window (1200) is not able to show all Desktops within the Group, a user can e.g. scroll the Navigation-Window (1200) using the arrows (1201, 1202) on each side of the Navigation-Window (1200). In an embodiment a Navigation-Window (1200) can be opened, closed, moved and resized similar to any other type of Window, however with the difference that it reside within the View it was opened at and does not have a position on the Desktop viewed by the View.

FIG. 13 shows an example of how the Navigation-Window described in FIG. 12 can be used. In an embodiment a View (1300) is a view of a section of a Desktop (1310) and have a Navigation-Window (1304) located at the top of the View (1300). The Navigation-Window (1304) shows in this example three different Desktops (1310, 1320, 1330) in the Group, where the View (1300) is visualized in the Navigation-Window (1311) with stripes (1311). This can help the user understand where the View (1300) is located and if the user views a section of a Desktop or the entire Desktop—in this example View (1300) is a section of a Desktop (1310). In addition the Navigation-Window shows another user has a View (1321) of another Desktop (1320), in this scenario the View (1321) is a view of the whole Desktop (1320). Similar to the first user, the second user has a View (1351) and a Navigation-Window (1352) as well as a Window (1356) within the View (1351). The second users Navigation-Window (1352) shows two Desktops (1360, 1370), the user can scroll the Navigation-Window (1352) using the arrows (1350, 1353) in the Navigation-Window (1352) to see other Desktops in the Group. In an embodiment a Navigation-Window (1352) can visualize the users View (1371) marked as e.g. dots of the area in view; as well as mark other users Views (1361). Even though this scenario shows a Navigation-Window at the top of a View the Navigation-Window can in an embodiment be located anywhere within a View.

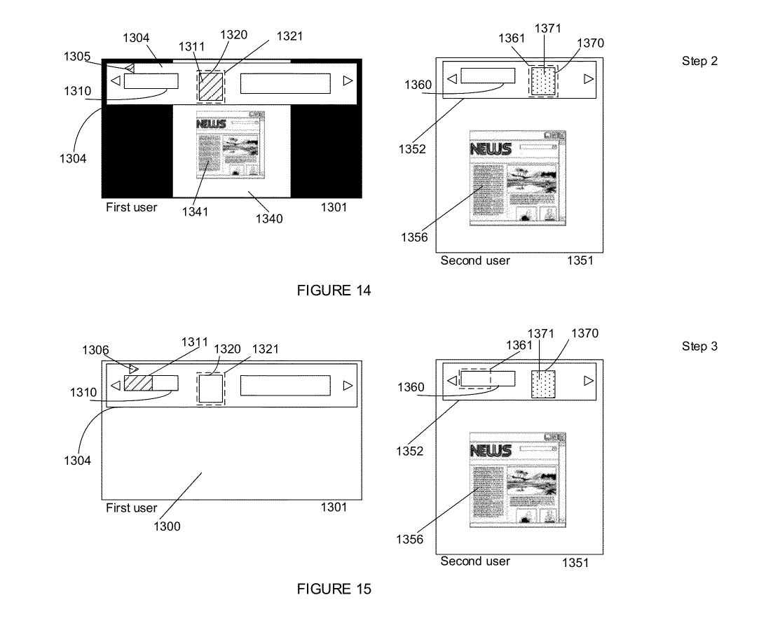

FIG. 14 is a continuation of FIG. 13 and shows how first user changed his View from one Desktop to the view of a Desktop that the second users is viewing. In an embodiment first user moved from a view of Desktop (1310) to a View (1340) similar to second users View (1321) of Desktop (1320), however because the first users View area's (1301) dimensions and proportions are different than the second users View area (1351), it means that View (1340) is resized to match the proportions of the view area available to display the View (1301) in. In an embodiment a Navigation-Window (1304) reflect the change in first users View (1301), where the marked View area (1311) is of Desktop (1320)—and the first user can see in the Navigation-Window (1304) that the second users View (1321) is the same as the first users View (1311). In addition the Navigation-Window (1304) can show a “back button” (1305), where the user can press the button to get back to the previous View. For the second user, the first users move only impact the Navigation-Window (1352) that now shows first user View (1361) is the same as the second user's View (1371).

FIG. 15 is a continuation of FIG. 14 and shows how first user has moved back to the first view. In an embodiment the first user has used the back button (1305) in FIG. 14 and is in this example now back to the original view (1300), where the View (1300) takes up the entire viewing area (1301). The first users Navigation-Window (1304) can reflect the change in view and display the View (1311) visualized with stripes and the second users View (1321) visualized with a punctured line. In an embodiment a “forward button” (1306) can be displayed in the Navigation-Window (1304) to enable the user to move to the previous view. In addition the second user's Navigation-Window (1352) can reflect the same change in view, where the first user's View (1361) is marked with dotted line.

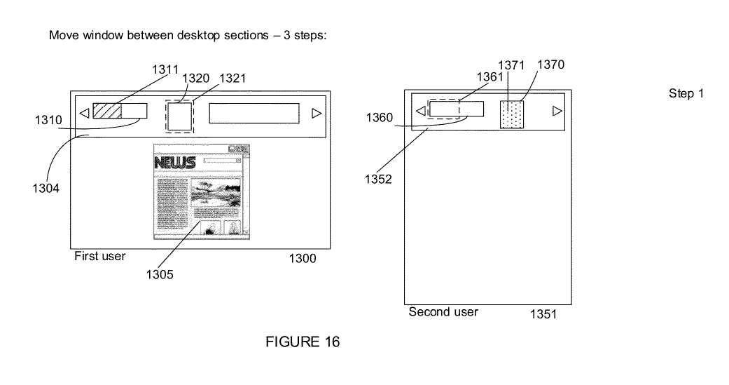

FIG. 16 shows an example of how a user can move a Window from one View to another View using a Navigation-Window. In an embodiment a first user has created a View (1300) and has a Window (1305) e.g. a web browser within View (1300). In this scenario the first user would like to move the Window (1305) to the second users View (1351) illustrated in the first users Navigation-Window (1304) as a punctured line (1321). The second user has a View (1351) of a different Desktop (1370) than the first user, who is viewing a section of Desktop (1310).

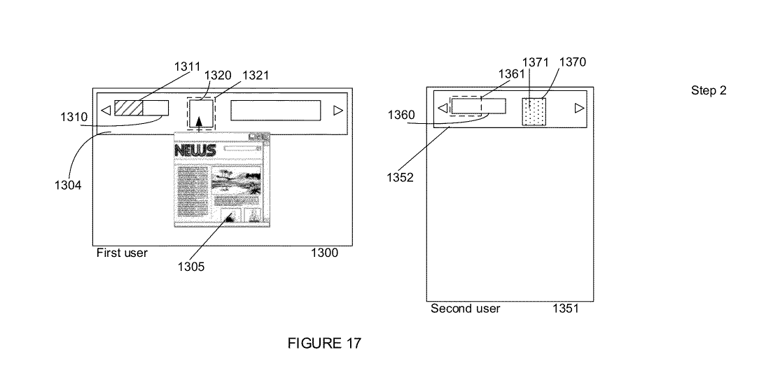

FIG. 17 is a continuation of FIG. 16 and shows how the first user can move the Window to the second user's Desktop. In an embodiment the first user move the Window (1305) over the visualized Desktop (1321) in the Navigation-Window (1304) that the first user would like to move the Window to and let go. The user can e.g. use a mouse, touch or other methods to complete a move of a Window.

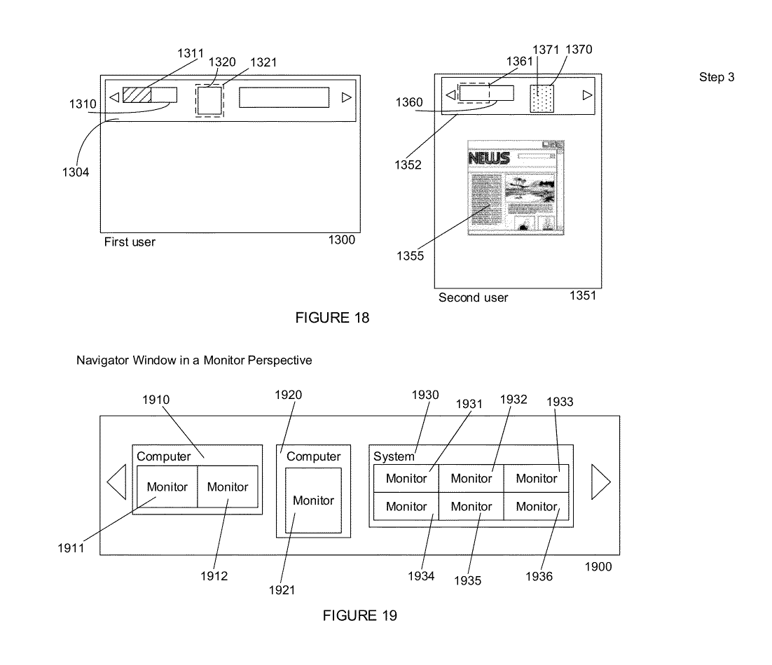

FIG. 18 is a continuation of FIG. 17 and shows how the Window has moved to the second user. In an embodiment when the first user let go of the Window (1305) from FIG. 17 over the visualized Desktop (1321), the Window (1355) is moved to the other Desktop (1320). In an embodiment this means that a Position-Window has moved from Desktop (1310) to Desktop (1320) with a new position and z-index on Desktop (1320) and same size/shape as before since no changes are made to the Source-Window; because the new Position-Window is within the View area (1370) it means that the View (1351) will create a new Render-Window, linked to the new Position-Window and subscribe to the Source-Window that Position-Window is linked to, the result is that from the user perspective the Window (1355) has moved from View (1300) of Desktop (1310) to View (1351) of Desktop (1320).

FIG. 19 shows an example of how the Navigation-Window can show computer and monitor areas as an alternative to showing Desktops within a Group of computers. In an embodiment a Navigation-Window (1900) can show which monitors are connected to which computer. For example a computer (1910) can have two monitors attached (1911, 1912), another computer (1920) can have one monitor attached (1921) and a system of computers (1930) can have e.g. six monitors attached (1931, 1932, 1933, 1934, 1935, 1936). This way of illustrating monitors as representing different sections of Desktop can work in fixed sized desktops and not unlimited Desktops. An embodiment could mix fixed Desktops with unlimited Desktops in the same group of computers and render this in a Navigation-Window. In this case only the fixed size Desktops can have individual monitors mapped out.

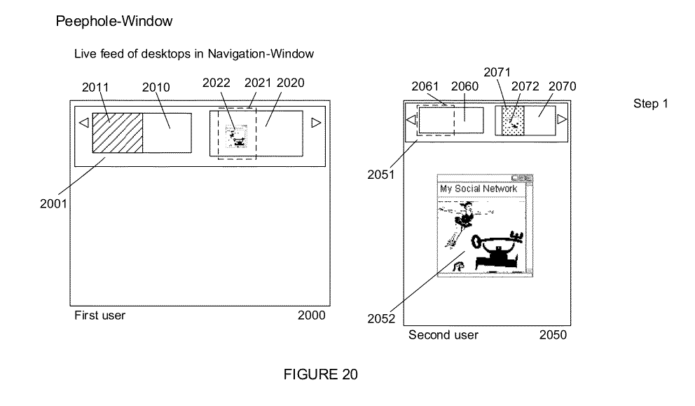

FIG. 20 shows an example of how a Navigation-Window can show a live feed of Window(s) that are within a View. In an embodiment a first user has created a View (2000) and a Navigation-Window (2001) and a second user has created another View (2050) that has a Window (2052) within the viewing area. In this example the first user's Navigation-Window (2001) shows a live rendering of the Window (2022) that is within the second users View (2021); similar the second user's Navigation-Window (2051) shows a live feed of the Window (2072) that is within the viewing area (2071). In an embodiment a live feed can be rendered using different methods such as e.g. bitmaps send real-time for each update, reduced frame rate of bitmaps send to the Navigation-Window and splash screens illustrating the area of a Window without e.g. showing the content of the Window. These alternative methods can contribute to lowering bandwidth and still provide some degree of live feed depending on what could be the most optimal in a given situation from a usage perspective.

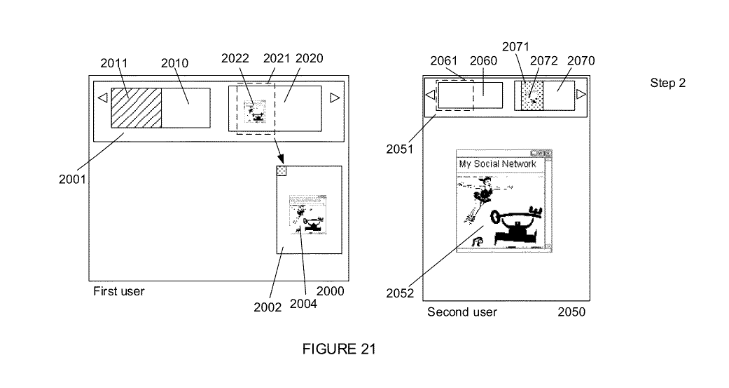

FIG. 21 is a continuation of FIG. 20 and shows how a Navigation-Window can be used to create a Peephole-Window. In an embodiment a first user has a View (2000) and a Navigation-Window (2001). In the Navigation-Window (2001) the first user can see the second users View (2021) and the Window (2022) that the second user has in view. The second user can similarly see its own View (2050) with Window (2052) as well as the Navigation-window (2051), where the second users View (2071) is marked with dots and the Window (2052) in Navigation-Window (2051) is rendered as a live feed (2072). The first user can in an embodiment create a Peephole-Window (2002) of the second users View (2021) by e.g. moving a copy of the visualized View (2021) out of the Navigation-Window (2001) and in to the view area (2000), where the Peephole-Window (2002) include meta-data for the Window (2004) within the Peephole-Window (2002). The resizable Peephole-Window (2002) maintains and follows the proportions of the View (2050) it is linked to.

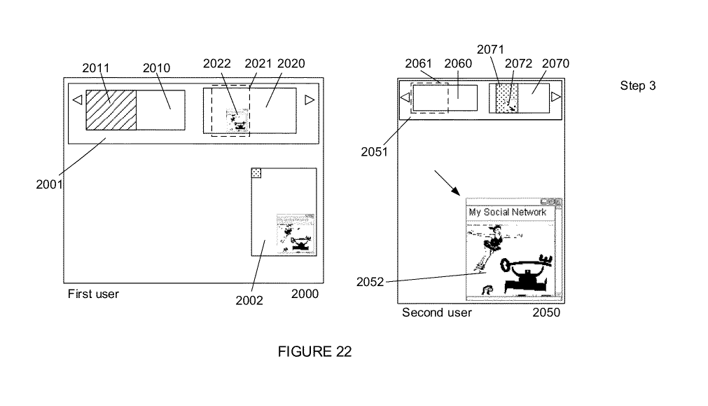

FIG. 22 is a continuation of FIG. 21 and shows how a move of a Window in one View is reflected in another user's Navigation-Window and Peephole-Window. In an embodiment a second user move a Window (2052) that is within the second users View (2050) to a new position within the View (2052). In this example the move is to the lower left corner of the View (2050) and is reflected instantly in the second users live feed (2072) of the View (2071) in the Navigation-Window (2051); similarly the move is reflected in the first users Peephole-Window (2002) as well as the live feed (2022) of the second users View (2021) in the first users Navigation-Window (2001).

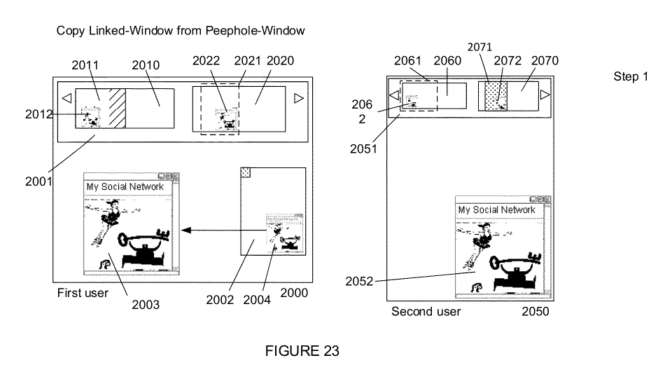

FIG. 23 shows an example of how a Window that is copied from one View to another using a Peephole-Window is linked to the Window it originates from. In an embodiment first user has a View (2000) of a section of Desktop (2010) and a separate Peephole-Window (2002) is placed on top of the View (2000). This peephole-Window (2002) is linked to the second users View (2050) that currently views the Desktop (2020/2070). On the Desktop viewed through the Peephole-Window (2002) there is a Window (2004) that the first user copies to the first user View (2000). In this example the first user can create a Linked-Window copy by dragging the Window (2004) in to the View (2000) illustrated with the arrow. Since the Linked-Window copy (2003) appears in first user View (2000), a live feed (2012) of this Window (2003) appears in first user's Navigation-Window (2001). At the same time a live feed (2062) of first user's Window (2003) is shown in second user's Navigation-Window (2051). In an embodiment a Window (2003) can be copied from a Peephole-Window (2002) with meta-data for this Window (2004), where meta-data include contact information for the Source-Window. In an embodiment where a Window (2003) is copied using a Peephole-Window (2002), a new Position-Window linked to the same Source-Window is created—and because the Position-Window is within the viewing area, the View (2000) creates a new Render-Window linked to the new Position-Window and subscribe to the Source-Window that this Position-Window is linked to. From a user's perspective a copy of a Window (2004) in a Peephole-Window (2002) can e.g. appear to look like a new version of the Window (2003) is dragged into the users View (2000).

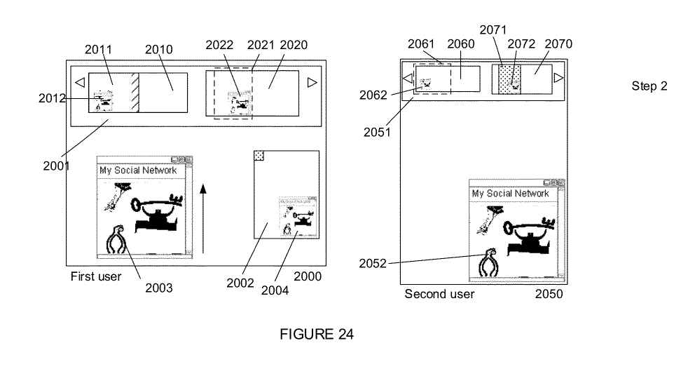

FIG. 24 is a continuation of FIG. 23 and shows how a Linked-Window copy of a Window can impact the original Window. In an embodiment first user scroll Window (2003) that is a Linked-Window with a link to the same Source-Window as Window (2052), in this scenario second user's Window (2052) scrolls to the same position of the content as Window (2003). In addition because Window thumbnails (2012, 2062) are live feeds of Window (2003), those Windows scrolls as well; this means that Window thumbnails (2022, 2012, 2062, 2004, 2072) that are live feeds will scroll because Window (2003) scroll. In an embodiment all Windows that are linked to the same Source-Window is impacted by any input made to the Window, regardless if it is e.g. a scroll, adding, deleting, editing. The user input collected by the Render-Window is send to the Source-Window that then does calculations based on the input and create an output such as e.g. a new bitmap or new meta-data that is then delivered to all Render-Windows that subscribes to this Source-Window.

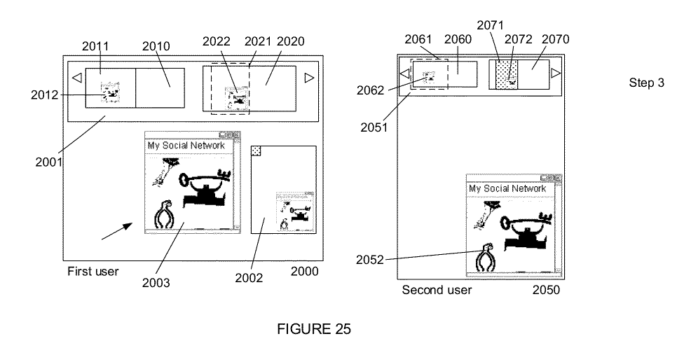

FIG. 25 is a continuation of FIG. 24 and shows how moving a linked copy of a Window does not impact the original Window's position. In an embodiment a first user can move a Window (2003) that is linked to the same Source-Window as Window (2052) in View (2050) without impacting the position of Window (2052) in the View (2050). However the live feed (2012, 2062) in Navigation-Window (2001, 2051) moves as well because it is linked to the same Position-Window as Window (2003). The Window (2003) can in this example move without impacting the position of other Windows linked to other Position-Windows such as e.g. Window (2052).

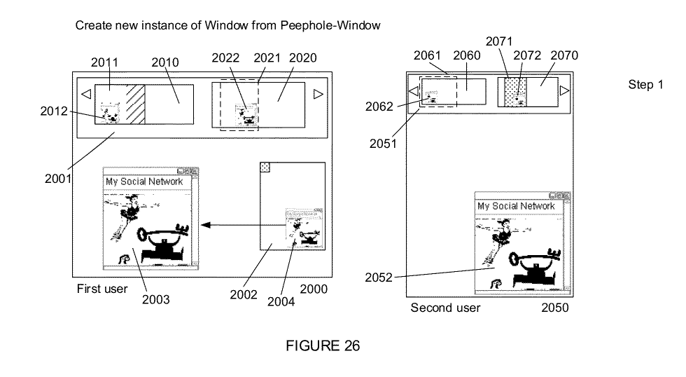

FIG. 26 is a continuation of FIG. 23 and shows how a new instance of a Source-Window for a Window in a Peephole-Window is created. In an embodiment first user has a View (2000) and a Peephole-Window (2002) linked to second users View (2050), the first user has the option to create a new & separate instance of the Window (2052) that the second user has in View (2050) by e.g. dragging the Window (2004) from the Peephole-Window (2002) to the View (2000) as shown with the arrow. In this scenario Window (2003) is a new instance of Window (2004) created from the Peephole-Window (2002) that includes meta-data about the rendered Windows such as e.g. access information to Source-Windows from where the current state can be copied into a new created instance of a Source-Window. In an embodiment the creation of a new instance of a Window means that a new Position-Window is created and is linked to a new instance of the Source-Window, where the state from the original Source-Window is copied to the new Source-Window and where the Render-Window for this new Window (2003) is subscribing to the new Source-Window and is linked to the new Position-Window. The new Source-Window can in this example be created on any accessible computer.

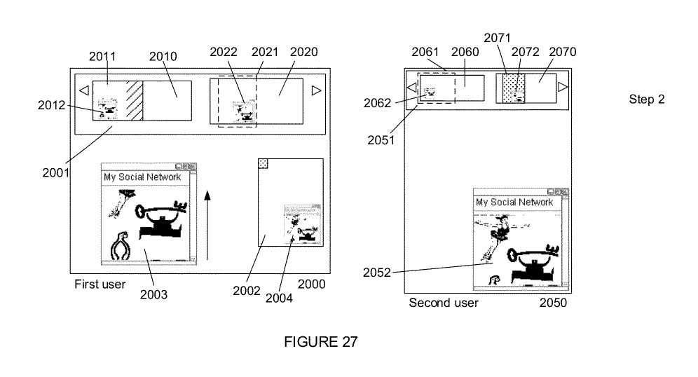

FIG. 27 is a continuation of FIG. 26 and shows an example of how a scroll of a Window with a new Source-Window instance will have no effect on the original Render-Windows linked to the original Source-Window the new Source-Window was created from. In an embodiment first user scroll Window (2003) in View (2000), however because the Window (2003) is linked to another Source-Window than the original Source-Window linked to Window (2052), the scroll impacts only the new Source-Window linked to Window (2003) that the first user is scrolling i.e. Window (2003) as well as the live feed (2012) in first user's Navigation-Window (2001) and the live feed (2062) in second users Navigation-Window (2051); while the Window (2004) in Peephole-Window (2002) and second user's Window (2052) in View (2050) is not impacted by the scroll since they are linked to the original Source-Window.

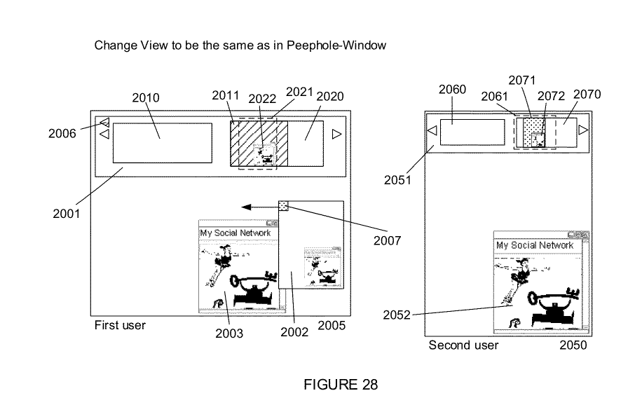

FIG. 28 is a continuation of FIG. 22 and shows an example of how a user can change viewing area using a Peephole-Window as reference for what to view. In an embodiment a first user can change the View (2005) to be the same as the Peephole-Window's viewing area (2050) by activating e.g. a button on the Peephole-Window (2007). In this scenario the current View (2005) changes its viewing area to the Desktop and area covered by View (2050) linked to the Peephole-Window (2002). If the proportions of the View (2005) and the proportions of the linked Peephole-Window's View are different, then a larger area is covered by the View (2005) as shown in this example. In an embodiment the new viewing area of the View (2005) can be reflected in first users Navigation-Window (2001) as View (2011) illustrated as stripes. In addition the Navigation-Window can have a back button (2006) similar to FIG. 14. In an embodiment a Peephole-Window (2002) includes meta-data about which Desktop/section of Desktop is in View.

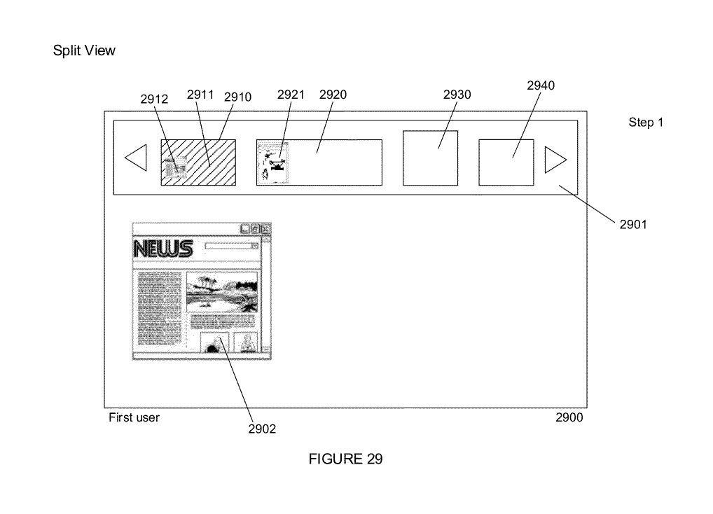

FIG. 29 shows an example of a View with a Navigation-Window. In an embodiment first user has a View (2900) with a Window (2902) within View area (2900) and a Navigation-Window (2901) that shows View (2911) with Window (2912) is a view of Desktop (2910). In addition the Navigation-Window (2901) can show a Window (2921) located on Desktop (2920), the Navigation-Window (2901) also shows two other Desktops (2930, 2940). In an embodiment a Navigation-Window (2901) can give a user an overview over Desktops (2920, 2930, 2940) in a Group and Windows (2921/2912) located on Desktops within that Group.

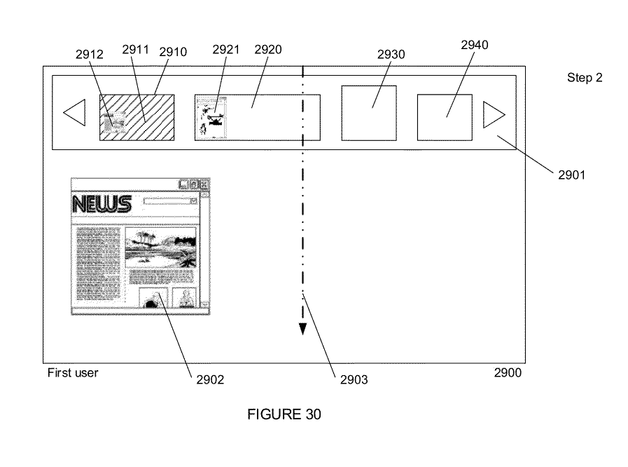

FIG. 30 is a continuation of FIG. 29 and shows an example of how a user can split a View into two. In an embodiment first user has a View (2900) with a Window (2902) and a Navigation-Window (2901). First user can in an embodiment split a View into two by e.g. use a gesture to drag from top to bottom on view area as illustrated with the punctured arrow (2903). In an embodiment a user can use e.g. mouse and touch gestures to create a movement (2903) that creates a splitting of the View into two.

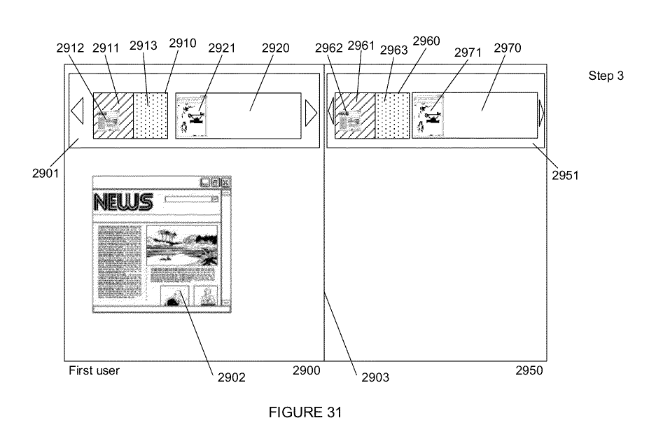

FIG. 31 is a continuation of FIG. 30 and shows an example of how two Views are located next to each other with a divider between them. In an embodiment first user has split a View in two, where one View (2900) takes up one section of the monitor area and another View (2950) takes up the rest of the monitor area, the split between the Views (2900, 2950) is show with a line (2903). In this example a Window (2902) is located in View (2900). In addition to splitting the View into two Views (2900, 2950), two Navigation-Windows (2901, 2951) can also be opened—one for each View. In an embodiment Navigation-Window (2901) can show how the two views (2900, 2950) is located on the Desktop (2910), where one View (29) is visualized with stripes (2912) and the other View (2950) is visualized with dots (2913); similarly for Navigation-Window (2951) in View (2950) the two Views are visualized—one View (2900) visualized with stripes (2061) and the other View (2950) is visualized with dots (2063).

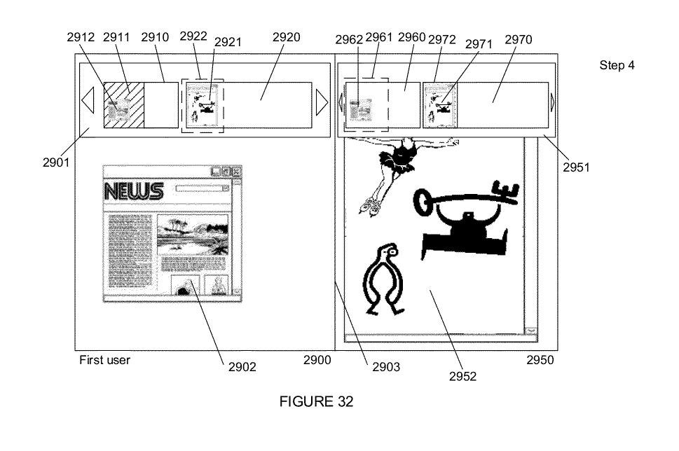

FIG. 32 is a continuation of FIG. 31 and shows an example of how a second View can change to view another section of another Desktop without impacting the first View. In an embodiment first user change the View (2950) to another area of the Desktop (2970) visualized in the Navigation-Window (2951) as dotted area (2972). In this example the first user has one View (2900) with Window (2902) within View and because first user change the second View (2950) to another Desktop (2970) that has a Window (2971) in View, the Window (2952) is now rendered in View (2950). This is reflected in the Navigation-Window (2951) that based on the change in View shows View (2961) of a section of Desktop (2960) and with a Window (2962) within View (2961); similar for Navigation-Window (2951) View (2972) is viewing a section of Desktop (2970) with Window (2971) in View (2950).

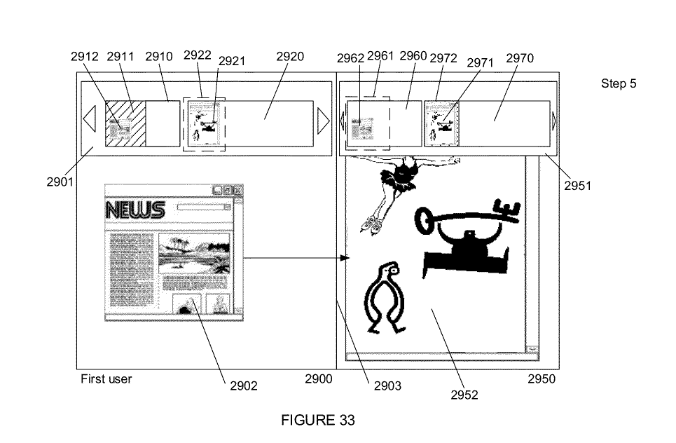

FIG. 33 is a continuation of FIG. 32 and shows an example of how a Window located at one position in a View of a Desktop or section of a Desktop can be moved to a neighboring View of a section of the same or another Desktop. In an embodiment first user have e.g. two Views (2900, 2950), where one Window (2902) is located in the first View (2900). In this example the Window (2902) can be moved to a neighboring View (2955) by moving the Window (2902) across the divider (2903) in this scenario marked as an arrow indicating direction of movement, where the Window (2902) is moved between two Desktops. In an embodiment a Window can be moved across a divider of Views as an alternative to moving a Window between Desktops using a Navigation-Window or a Peephole-Window, where the method of moving across a divider is visually different from a users perspective, the underlying system and method behind moving a Window is the same as when moving a Window using a Navigation-Window and a Peephole-Window. In an embodiment a Position-Window moves to another Desktop or another section of the same Desktop, while the link to the Source-Window is kept and where the View rendering the Desktop that the Position-Window is moved to create a new Render-Window subscribing to the same Source-Window linked to this Position-Window. In an embodiment the process of moving a Window between Views applies regardless of how the perimeter of a view is defined, moving a window over the perimeter can trigger the move from the first View to the second View.

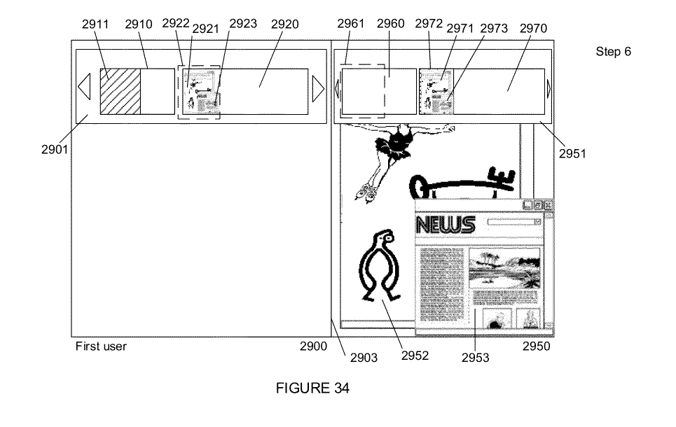

FIG. 34 is a continuation of FIG. 33 and shows an example of how the Window is moved to the neighboring View. In an embodiment first user can move a Window (2902) from one View (2900) to another View (2955) by moving it across the divider (2903) between the two Views (2900, 2950), where the split can e.g. horizontally or vertically divide the Views. In an embodiment a Navigation-Window (2901) reflect the change of a moved Window, where the Window (2923) is rendered in the new position of View (2922) on Desktop (2920) and where View (2911) on Desktop (2910) no longer render the Window. In an embodiment a Window can be moved between Views even though the View's area is located on different Desktops that are within the same Group regardless of where those Desktops are located and which computer(s) the Desktop(s) is owned by.

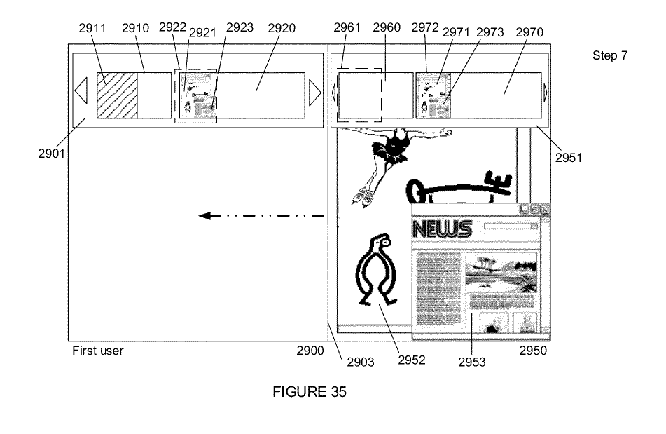

FIG. 35 is a continuation of FIG. 34 and shows an example of how a View can be resized by moving a divider. In an embodiment a View (2950) is resized by moving a divider (2903) from e.g. right to left as indicated with the punctured arrow.

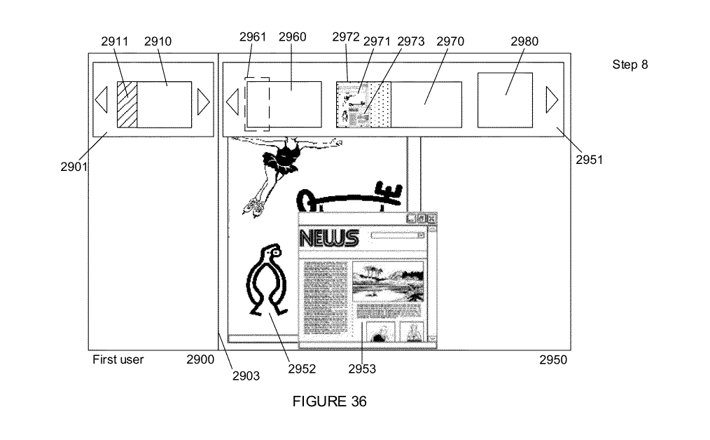

FIG. 36 is a continuation of FIG. 35 and shows an example of two views that have been resized. In an embodiment a first user can drag a divider (2903) in one direction to resize two Views (2900, 2950). In this example a View (2950) has it starting point at the same location as the starting point of Desktop (2970), which mean that in a scenario where first user enlarge one View (2950) by making it wider, the view can include a wider section of the Desktop area. In an embodiment Window's (2952, 2953) can keep their position in relation to the View's (2950) starting point when making the View (2950) wider, unless the Window is moved independently and therefore gets a new position in relation to the View's starting point. A Navigation-Window (2951) is in this example reflecting the changes in view size; and by having a wider Navigation-Window (2951) it can therefore show an additional Desktop (2980). In addition the Navigation-Window (2951) illustrates how the View (2972) is viewing a larger section of the Desktop (2970) compared to before the move (FIG. 35); similar View (2961) of Desktop (2960) has less width than what it had before the divider (2903) was moved. In an embodiment a Navigation-Window (2901) can adjust its size dynamically to fit the size of a View (2900).

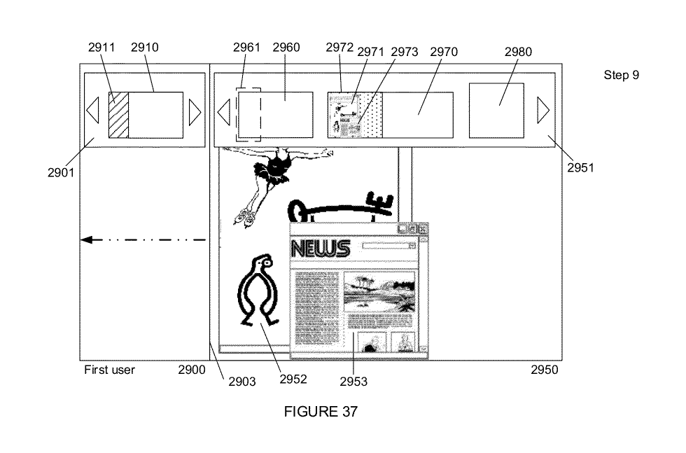

FIG. 37 is a continuation of FIG. 36 and shows an example of how a View can be deleted using a divider. In an embodiment first user can delete a View (2900) by moving the divider (2903) to the edge of the viewing area as illustrated with the punctured arrow, where a gesture similar to resizing a View can be used to delete a View (2900) by continue the gesture to the edge of a viewing area.

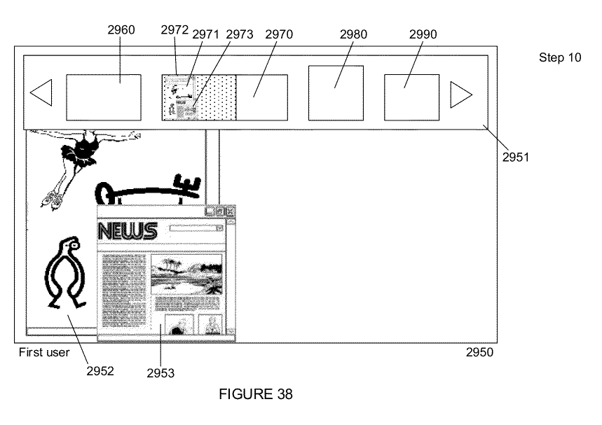

FIG. 38 is a continuation of FIG. 37 and show an example of how deleting a View has impact on the neighboring View. In an embodiment first user can delete a View (2900) by moving the split (2903) all the way to the edge of the viewing area, in this example the neighboring View (2950) takes up the entire viewing area; similar to FIG. 36 the View width expand to a larger area of the Desktop (2970) as illustrated in View (2972) marked with dots. In an embodiment the Navigation-Window (2951) can adjust its width to be similar to the width of the View (2955), however it doesn't have to and a user can modify the size of a Navigation-Window and located it where the user find most optimal.

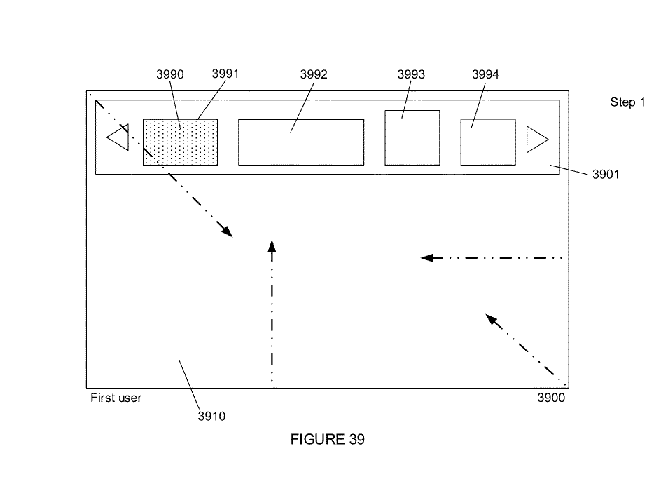

FIG. 39 shows an example of how a user can split a view area into as many sections or new Views as optimal for that user. In an embodiment first user has a View area (3900) and a View (3910) with a Navigation-Window (3901) illustrating that the View (3990) is of Desktop (3991). First user can in this example split the View (3910) from any side or corner of the View area (3900) by e.g. dragging from a corner or side using mouse or touch—illustrated in this example with punctured arrows.

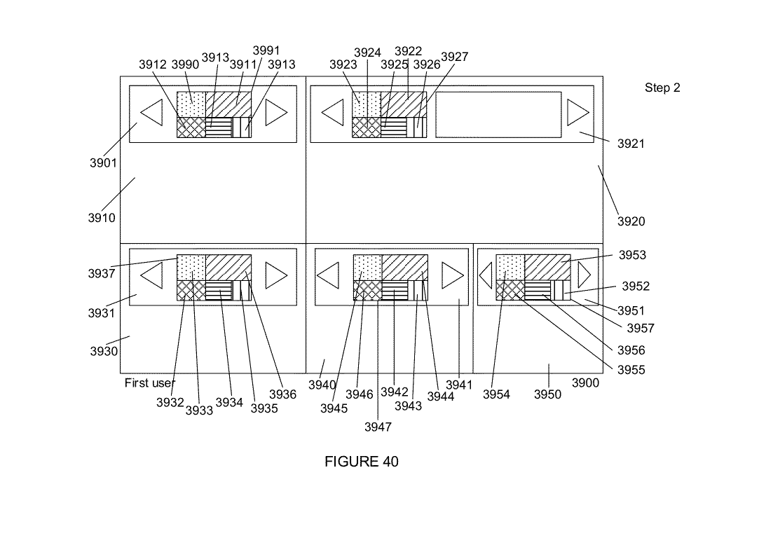

FIG. 40 is a continuation of FIG. 39 and shows an example of a view area split into a number of Views. In an embodiment first user creates new Views (3920, 3930, 3940, 3950) based on an existing View (3910 from FIG. 39) by dragging a line from the corners and sides to create new Views. In this example a Navigation-Window (3901, 3921, 9331, 3941, 3951) is created for each View (3910, 3920, 3930, 3940, 3950), where each of the Views created is marked with a color (in this example color is marked as horizontal, vertical, diagonal and crossed stripes as well as dots) for each view area. In this example View area (3900) of Desktop (3991) is split into five Views (3910, 3920, 3930, 3940, 3950) where each View is reflected in each Navigation-Window (3901, 3921, 3931, 3941, 3951).

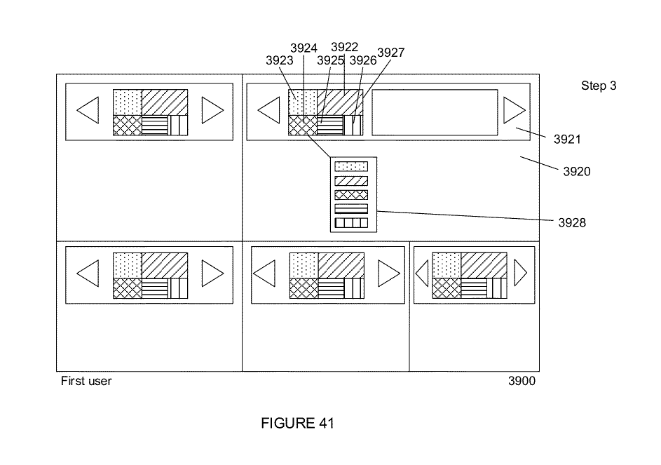

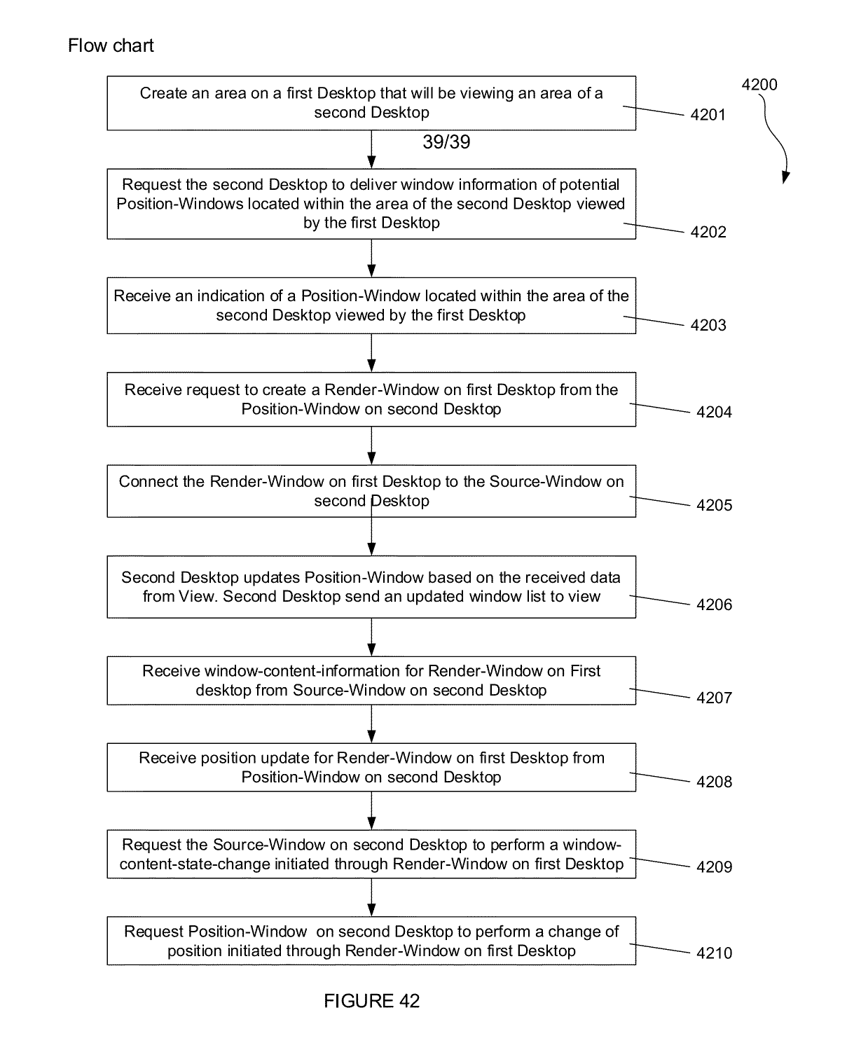

FIG. 41 is a continuation of FIG. 40 and shows an example of how a user can see a list of Views for any user in the Group. In an embodiment first user can click on a View (3924) in a Navigation-Window (3921) to see a list of additional Views (3928) the user has, the list of views can be illustrated using e.g. color. In an embodiment first user can see a list of all Views first user has as well as any other user(s) has within the Group(s) at any given point in time, where the list is updated dynamically and reflect change in Views such as e.g. number of views and the size of each view for any user within the Group that first user is part off. In an embodiment the visualization of Views from first user inside a Navigation-Window can be important when first user have Views of many different desktops and second user want to get an overview of what first user is looking at and use that overview to select to jump to any of those views or create a Peephole-Window linked to any of those views. If e.g. the number of views for first user is large, they may not all show on the same scroll position of the Navigation-Window, this is where a list of views for a particular user can be useful.
FIG. 42 shows an example of a flow diagram from the View perspective focusing on the interactions between Position-Window, Render-Window and Source-Window (4200). In this example the Position-Window is owned by the second Desktop; the Render-Window is owned by the View located on the first Desktop and the Source-Window is owned by the Source that can be located on any Desktop. In an embodiment the first step (4201) can be to create a View on a first Desktop of a second Desktop, where the View is an area on the first Desktop that will be viewing an area of a second Desktop. The View can for example be a section of or the entire second Desktop. In an embodiment the second step (4202) can be that View request second Desktop to deliver Position-Window information for example position and z-index of each Position-Window that is located completely or partially within the viewed area of the second Desktop. In an embodiment the third step (4203) can be a response to the View's request (4202). In this example the second Desktop deliver this information by for example mapping the area of each Position-Window on its desktop against View of first Desktops viewing area. In an embodiment the mapping can result in a list of null, one or many Position-Windows, depending on which Position-Windows that are located completely or partially within the viewed area of the second Desktop. In an embodiment the fourth step (4204) can be that second Desktop request View to create Render-Window(s) for each Position-Window that are within the viewed area, where the Render-Window can be the same size as the Position-Window that is within the viewed area. In an embodiment the fifth step (4205) can be that Position-Window(s) on second Desktop send connection information to Render-Window(s) located on the first Desktop for how to connect to the associated Source-Window. The connection information can for example be a port and an IP address or hostname. In an embodiment the sixth step (4206) can be that Render-Window(s) connect to Source-Window(s) based on the information provided by Position-Window(s) on the second Desktop. In an embodiment the seventh step (4207) can be that Render-Window(s) on first Desktop receive window information such as for example meta-data and bitmaps from Source-Window. In an embodiment Source-Window can be located on second Desktop, first Desktop or any other Desktop. In an embodiment the eight step (4208) can be that Render-Window(s) on first Desktop receive position update information from Position-Window(s) located on second Desktop. In an embodiment the ninth step (4209) can be that View request Source-Window to perform a potential window-content-change initiated through Render-Window(s) on first desktop. The window-content-change can for example be input such as resize of Render-Window or for example mouse or keyboard events. The Source-Window can in this example decide to change the window-content-change and send the result to Render-Window. In an embodiment the tenth step (4210) can be that View request Position-Window on second Desktop to perform a potential change of position through Render-Window on first Desktop. The position change can for example be initiated by a move of the Render-Window with for example mouse or keyboard events. The Position-Window can in this example decide to change the position of the Position-Window and send the result to Render-Window.

What is claimed is:

1. A system for decoupling desktop windows in a multiple desktop environment, comprising:
a computer including a processor;
a logic for displaying one or more desktop windows on one or more display devices, according to an ownership model that supports decoupling the one or more desktop windows in response to an interaction from a user.

2. The system of claim 1, wherein the one or more desktop windows are linked by the ownership model including that
each of one or more source windows is owned by a source responsible for launching and executing that source window,
each of one or more position windows is owned by a desktop and is linked to a source window, and
each of one or more render windows is owned by a view, is linked to a position window, and renders an area of a desktop for display to the user.

3. The system of claim 1, wherein the interaction from the user includes one or more copying or moving of windows or contents therein between the desktop windows.

4. The system of claim 1, wherein the system includes a plurality of computers and wherein responsibilities for the one or more source windows, one or more position windows and one or more render windows is distributed over the plurality of computers.

5. The system of claim 1, wherein a selection of the computers can be grouped and their windows shared within a group.

6. A method for decoupling desktop windows in a multiple desktop environment, comprising:
displaying one or more desktop windows on one or more display devices, according to an ownership model that supports decoupling the one or more desktop windows in response to an interaction from a user.

7. The method of claim 6, wherein the one or more desktop windows are linked by the ownership model including that
each of one or more source windows is owned by a source responsible for launching and executing that source window,
each of one or more position windows is owned by a desktop and is linked to a source window, and
each of one or more render windows is owned by a view, is linked to a position window, and renders an area of a desktop for display to the user.

8. The method of claim 6, wherein the interaction from the user includes one or more copying or moving of windows or contents therein between the desktop windows.

9. The method of claim 6, wherein the system includes a plurality of computers and wherein responsibilities for the one or more source windows, one or more position windows and one or more render windows is distributed over the plurality of computers.

10. The method of claim 6, wherein a selection of the computers can be grouped and their windows shared within a group.

11. A non-transitory computer readable medium, including instructions stored thereon which when read and executed by one or more computers cause the one or more computers to perform the steps comprising:
displaying one or more desktop windows on one or more display devices, according to an ownership model that supports decoupling the one or more desktop windows in response to an interaction from a user.

12. The non-transitory computer readable medium of claim 11, wherein the one or more desktop windows are linked by the ownership model including that
each of one or more source windows is owned by a source responsible for launching and executing that source window,
each of one or more position windows is owned by a desktop and is linked to a source window, and
each of one or more render windows is owned by a view, is linked to a position window, and renders an area of a desktop for display to the user.

13. The non-transitory computer readable medium of claim 11, wherein the interaction from the user includes one or more copying or moving of windows or contents therein between the desktop windows.

14. The non-transitory computer readable medium of claim 11, wherein the system includes a plurality of computers and wherein responsibilities for the one or more source windows, one or more position windows and one or more render windows is distributed over the plurality of computers.

15. The non-transitory computer readable medium of claim 11, wherein a selection of the computers can be grouped and their windows shared within a group.
